(19) United States
(12) Patent Application Publication
(10) Pub. No.: US 2008/0184905 A1
(43) Pub. Date: Aug. 7, 2008

(54) Method of Operating a Dampening Unit in a Printing Press and Printing Press Having a Dampening Unit

(75) Inventors: Olaf Dauber, Karlsruhe (DE); Martin Dietze, Langen (DE); Ralf Schmitt, Leimen (DE); Hans Schwerdter, Heidelberg (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/026,585

(22) Filed: Feb. 6, 2008

(30) Foreign Application Priority Data
Feb. 6, 2007 (DE) 10 2007 005 957.6

(51) Int. Cl. B41F 1/16

(52) U.S. Cl. 101/492

(57) ABSTRACT

A method of operating a dampening unit in a printing press includes providing a first dampening solution applicator roller rolling on a plate cylinder with slip relative to the plate cylinder, and a second dampening solution applicator roller simultaneously rolling on the plate cylinder. As the two dampening solution applicator rollers roll on the plate cylinder, there is a circumferential surface-speed difference between the first dampening solution applicator roller and the second dampening solution applicator roller. A printing press having a dampening unit is also provided.

### CROSS-REFERENCE TO RELATED APPLICATION

This application claims the priority, under 35 U.S.C. §119, of German Patent Application DE 10 2007 005 957.6, filed Feb. 06, 2007; the prior application is herewith incorporated by reference in its entirety.

### BACKGROUND OF THE INVENTION

### Field of the Invention

The present invention relates to a method of operating a dampening unit in a printing press, in which a first dampening solution applicator roller rolls on a plate cylinder with slip relative to the plate cylinder and a second dampening solution applicator roller simultaneously rolls on the plate cylinder. The present invention also relates to a printing press having a dampening unit.

The invention was made in the following context: Offset printing presses frequently print sheets of a format that is smaller than the maximum format the press can process. The printing plate should only carry dampening solution and no ink in the region that is outside the smaller format. However, in practice, individual ink particles cannot be prevented from entering into that plate region. The printing plate then transfers those ink particles to an area of the blanket that is outside the format of the sheet and will not come into contact with the sheet. The sheet will not take over the ink particles from the blanket due to the lack of contact with the sheet. As a result, the ink particles accumulate on the lateral edges and the trailing edge of the blanket. The accumulated ink will then be transferred from the blanket cylinder to the impression cylinder in a region of the latter that is not covered by the sheet and consequently becomes dirty. That undesirable effect is known as “framing”. The impression cylinder will then transfer the dirt to the back sides of the sheets of a subsequent print job if the format of those sheets is larger than that of the sheets of the current print job. The back sides may already be printed, which means that the printed image becomes damaged by the dirt. Even if the back sides have not been printed, the dirt may cause complications. If the back sides remain unprinted, they would no longer be as white as the unsoiled paper. If the back sides were to be printed in a subsequent print run, the dirt would reduce the quality of the image printed on the back sides.

A known way to counteract framing is to use pad sheets having dimensions which precisely match those of the smaller-format print sheets to be printed. Such a pad sheet is placed underneath the blanket in such a way that the blanket has a raised region that is congruent with the print sheet. The region of the blanket that is outside the raised region does not come into contact with the printing plate and will consequently not receive any ink particles from the latter. However, a disadvantage of that measure is that the format of the pad sheets must be adjusted when the format of the print sheets changes from print job to print job. That requires dismounting of the blankets. The more printing units that need to be changed over in the press, the more time-consuming that process becomes.

In the context of the present invention, it has been found that various factors increase the framing effect. One of those influencing factors is the use of modern printing plates that receive an image in a thermal process rather than by violet light. Presumably, the film layer thickness of the dampening solution present on such a thermal plate is smaller than that on the conventional “violet” plates. Consequently, the framing effect tends to occur more frequently when thermal plates are being used. Another factor is the use of a dampening solution applicator roller with a hickey remover function in the dampening unit of the printing press. Such a roller rolls on the printing plate with a speed difference between the circumferential surface of the roller and the circumferential surface of the plate cylinder. Due to that slip, the roller is able to remove what are known as hickeys, i.e. dirt particles, for example in the shape of detached paper fibers, from the printing plate and to keep the printing plate clean during printing. However, the slip has a detrimental effect on the dampening solution film in the printing plate region outside the print sheet format and thus increases the framing effect.

German Patent DE 10 2004 006 231 B3 discloses a method of operating a dampening unit that includes a first dampening solution applicator roller and a second dampening solution applicator roller. The two dampening solution applicator rollers are driven in such a way that the circumferential speed of the first dampening solution applicator roller and the circumferential speed of the second dampening solution applicator roller either match the circumferential speed of a plate cylinder or are in a constant relationship relative to the circumferential speed of the plate cylinder. The two dampening solution applicator rollers contact a dampening unit roller that is driven in such a way that there is slip between the dampening unit roller and the first dampening solution applicator roller, between the dampening unit roller and the second dampening solution applicator roller, or between the dampening unit roller and both the first dampening solution applicator roller and the second dampening solution applicator roller. Driving the dampening unit in such a way does not solve the framing problem explained above in a satisfactory way.

### BRIEF SUMMARY OF THE INVENTION

It is accordingly an object of the invention to provide a method of operating a dampening unit in a printing press and a printing press having a dampening unit, which overcome the hereinafore-mentioned disadvantages of the heretofore-known methods and devices of this general type and which avoid or at least sufficiently reduce the framing effect.

With the foregoing and other objects in view there is provided, in accordance with the invention, a method of operating a dampening unit in a printing press. The method comprises providing a first dampening solution applicator roller rolling on a plate cylinder with slip relative to the plate cylinder, providing a second dampening solution applicator roller simultaneously rolling on the plate cylinder, and providing a circumferential surface-speed difference between the first dampening solution applicator roller and the second dampening solution applicator roller.

In accordance with the method of the invention, the two dampening solution applicator rollers are driven in such a way that there is a circumferential-speed difference not only between the first dampening solution applicator roller and the plate cylinder, but also between the two dampening solution applicator rollers, which have different circumferential-surface speeds.

In accordance with the method of the invention, hickeys can be removed without increasing the framing effect. The printing plate is kept clean during printing. Undesired ink build-up or accumulation on the blanket cylinder and on the impression cylinder is avoided. The measures proposed by the invention do not require a time-consuming change-over when the format of the print sheets changes and, without difficulty, accommodate the use of printing plates that are imaged in a thermal process.

In accordance with another mode of the invention, the second dampening solution applicator roller is in rolling contact with the plate cylinder in such a way that there is no circumferential-speed difference between the second dampening solution applicator roller and the plate cylinder.

In accordance with a further mode of the invention, there is a circumferential-speed difference between the second dampening solution applicator roller and the plate cylinder, and this circumferential-speed difference is smaller than the circumferential-speed difference between the first dampening solution applicator roller and the plate cylinder.

In accordance with an added mode of the invention, the circumferential speed of the first dampening solution applicator roller is outside the range from 95% to 105% of the circumferential speed of the plate cylinder, which means that the slip that is effective between the circumferential surfaces of the first dampening solution applicator roller and the plate cylinder is either more than +5% (e.g. +7%) or less than −5% (e.g. −7%) of the circumferential speed of the plate cylinder.

In the context of the present application, the respective slip or circumferential-speed difference is given with a positive sign when the circumferential speed of the respective dampening solution applicator roller is lower than that of the plate cylinder, and is given as a negative value when the circumferential speed of the respective dampening solution applicator roller is higher than that of the plate cylinder.

In accordance with an additional mode of the invention, the slip between the circumferential surfaces of the first dampening solution applicator roller and of the plate cylinder is positive in the sense of the definition given above and is more than 5%. Accordingly, the circumferential speed of the first dampening solution applicator roller is, for example, 93% of the circumferential speed of the plate cylinder if the slip is +7%.

In accordance with yet another mode of the invention, the value of the circumferential-speed difference percentage between the second dampening solution applicator roller and the plate cylinder in terms of the circumferential speed of the plate cylinder is not more than 3. If the circumferential speed of the second dampening solution applicator roller is higher than that of the plate cylinder, the circumferential-speed difference percentage may be negative, and if the circumferential speed of the second dampening solution applicator roller is lower than that of the plate cylinder, this percentage may be positive. If the circumferential-speed difference percentage is positive, its value is preferably 3 at maximum, and if the circumferential-speed difference percentage is negative, its value is preferably not more than 1, which means that the circumferential-speed of the second dampening solution applicator roller ranges from 97% to 101% of the circumferential speed of the plate cylinder.

In accordance with yet a further mode of the invention, the distance between the second dampening solution applicator roller and an inking unit associated with the plate cylinder for the purpose of applying ink to the plate cylinder, as viewed in the direction of rotation of the plate cylinder, is shorter than the distance between the first dampening solution applicator roller and the same inking unit. For example, as viewed in the direction of rotation of the plate cylinder, an ink applicator roller of the inking unit may be disposed directly downstream of the second dampening solution applicator roller along the circumference of the plate cylinder.

In accordance with yet an added mode of the invention, a dampening unit roller of the dampening unit contacts both the first dampening solution applicator roller and the second dampening solution applicator roller at the same time, and the rotation of the second dampening solution applicator roller is driven in a form-locking way through a gear mechanism including a first gearwheel that is connected to the dampening unit roller so as to rotate with the latter, for example fixed to the roller journal of the dampening unit roller, and a second gearwheel meshing with the first gearwheel and connected to the second dampening solution applicator roller so as to rotate with the latter. A form-locking connection is one which connects two elements together due to the shape of the elements themselves, as opposed to a force-locking connection, which locks the elements together by force external to the elements.

With the objects of the invention in view, there is concomitantly provided a printing press, comprising a dampening unit for implementing the method according to the invention.

For example, the printing press may include an electronic control device that is programmed in such a way that it controls the dampening unit in accordance with the method of the invention.

Other features which are considered as characteristic for the invention are set forth in the appended claims.

Although the invention is illustrated and described herein as embodied in a method of operating a dampening unit in a printing press and a printing press having a dampening unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, cross-sectional view of a first exemplary embodiment of a dampening unit suitable for implementing the method according to the invention;

FIG. 2 is a cross-sectional view of a modified version of the dampening unit shown in FIG. 1;

FIG. 3 is a cross-sectional view of a second exemplary embodiment of a dampening unit suitable for implementing the method according to the invention; and

FIG. 4 is a cross-sectional view of a modified version of the dampening unit shown in FIG. 3.

### DETAILED DESCRIPTION OF THE INVENTION

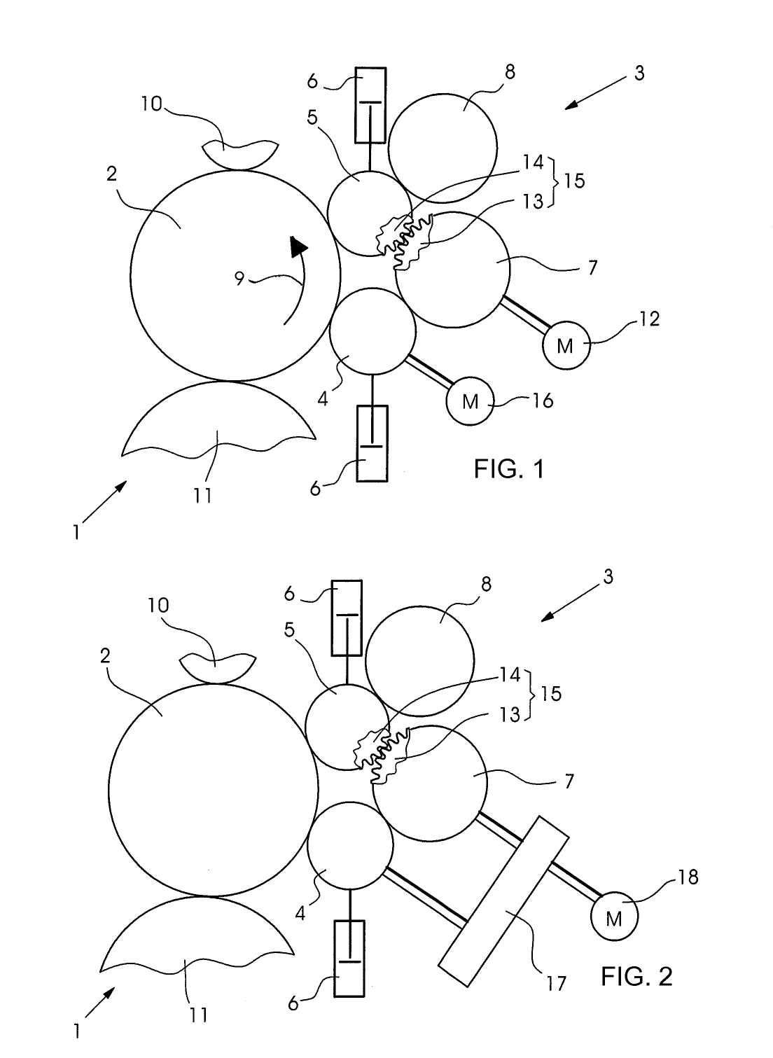

Referring now in detail to the figures of the drawings, in which corresponding elements and components are identified by the same reference numerals and are not described repeatedly, and first, particularly, to FIG. 1 thereof, there is seen a section of a printing press 1 for printing on sheets in a lithographic offset process. The section includes a plate cylinder 2 and a dampening unit 3 of the printing press 1. The dampening unit 3 includes a first dampening solution applicator roller 4 and a second dampening solution applicator roller 5. The two dampening solution applicator rollers 4, 5 can be engaged with and disengaged from the plate cylinder 2 through the use of actuators 6. The actuators 6 are pneumatic operating cylinders.

The dampening unit 3 further includes a dampening unit roller in the form of a distributor roller 7 that oscillates in the axial direction and a further dampening unit roller in the form of a metering roller 8, which exclusively contacts the second dampening solution applicator roller 5. The distributor roller 7 contacts both of the dampening solution applicator rollers 4, 5 at the same time. Moreover, the metering roller 8 contacts a further roller, which is not illustrated in the drawing for reasons of clarity. This further roller may be a fountain roller or another dampening unit roller or may contact such a roller and is used for feeding the dampening solution to the metering roller 8.

The printing press 1 further includes an inking unit that is only illustrated in part for reasons of clarity. The illustrated elements of the inking unit are a front or first ink applicator roller 10 as viewed in a direction of rotation 9 of the plate cylinder 2. Moreover, the printing press 1 includes a blanket cylinder 11 and a non-illustrated impression cylinder. The first dampening solution applicator roller 4 is disposed immediately downstream of the cylinder blanket 11 and immediately upstream of the second dampening solution applicator roller 5, in the direction of rotation 9 of the plate cylinder 2.

A first electric motor 12 drives the rotation of the distributor roller 7. A first gearwheel 13 that is coaxial with the distributor roller 7 and connected to the latter so as to rotate therewith, and a second gearwheel 14 that is coaxial with the second dampening solution applicator roller 5 and connected to the latter so as to rotate therewith, form a gear mechanism 15, which transmits the rotation of the first motor 12 to the second dampening solution applicator roller 5. The two gearwheels 13, 14, which mesh with each other, are only illustrated symbolically in the drawing. The rotation of the first dampening solution applicator roller 4 is driven by a second electric motor 16.

The two motors 12, 16 are separate motors that are independent of a non-illustrated main drive motor of the press 1 and are controlled in such a way that the first dampening solution applicator roller 4 runs with enough slip relative to the plate cylinder 2 for any hickeys that may be present on the plate cylinder 2 to be removed from the latter during printing. Moreover, the motors are controlled in such a way that the second dampening solution applicator roller 5 runs substantially without slip relative to the plate cylinder 2 to avoid the framing effect.

In accordance with a non-illustrated modified embodiment, the second motor 16 may be eliminated and the rotation of the first dampening solution applicator roller 4 may be driven exclusively by friction with the distributor roller.

In accordance with a further non-illustrated modified embodiment, both the second motor 16 and the gearing mechanism 15 may be eliminated. In this case, rotation of the second dampening solution applicator roller 5 is likewise driven by friction with the distributor roller 7. If the two dampening solution applicator rollers 4, 5 are driven exclusively by friction, the circumferential-speed difference required between these two rollers may be achieved by providing a brake that continuously brakes the first dampening solution applicator roller 4 during printing.

As is shown in FIG. 2, the second motor 16 shown in the dampening unit 3 of FIG. 1 can be eliminated if the first dampening solution applicator roller 4 and the second dampening solution applicator roller 5 are in drive connection with each other through a continuously variable transmission 17 and are drivable by a common electric motor 18 that is separate from the main drive motor of the printing press 1. The continuously variable transmission 17 provides continuous variation of the difference between the rotational speed of the first dampening solution applicator roller 4 and the rotational speed of the second dampening solution applicator roller 5.

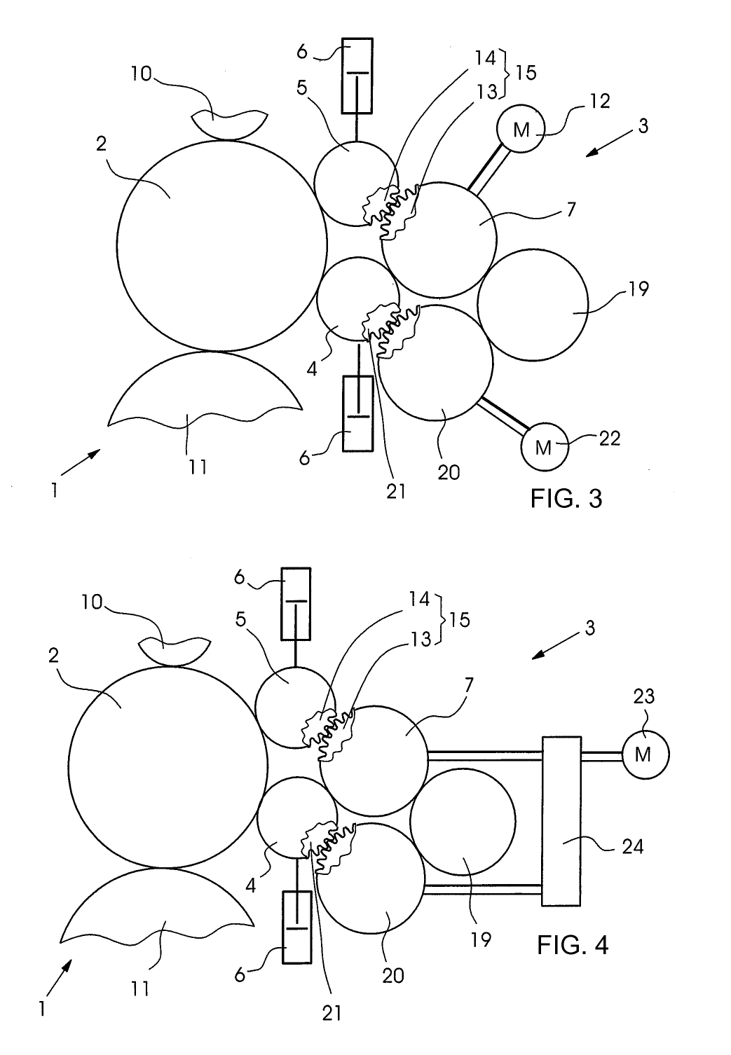

FIG. 3 illustrates an embodiment that differs from the exemplary embodiment shown in FIG. 1 only in the features that will be explained below. The embodiment shown in FIG. 3 does not include a metering roller 8 (see FIG. 1) that contacts the second dampening solution applicator roller 5. Instead, the dampening unit 3 of FIG. 3 includes a metering roller 19 that contacts both the distributor roller 7 and a dampening unit roller 20 at the same time. This dampening unit roller 20 is a distributor roller that oscillates in the axial direction and also contacts the first dampening solution applicator roller 4. The metering roller 19 contacts a further roller, which is not illustrated for reasons of clarity. This further roller may be a fountain roller or may contact such a roller and is used for feeding dampening solution to the metering roller 19.

The first dampening solution applicator roller 4 and the dampening unit roller 20 are rotatively connected to each other through a gear mechanism 21. The structure of the gear mechanism 21 is the same as that of the gear mechanism 15, and the gear mechanism 21 includes gearwheels that are firmly connected to axial journals of the rollers 4, 20 and mesh with each other. These gearwheels are indicated symbolically in the drawing.

An electric motor 22 that is separate from the main drive motor of the printing press 1 rotatively drives the dampening unit roller 20 and, through the gear mechanism 21, the first dampening solution applicator roller 4. The two motors 12, 22 are controlled by a suitably programmed electronic control device of the press 1 in such a way that there is a circumferential-speed difference between the circumferential speeds of the plate cylinder 2 and the first dampening solution applicator roller 4. This circumferential-speed difference is controlled to be high enough for the first dampening solution applicator roller 4 to have a cleaning effect on the plate cylinder 2 during printing. There is substantially no circumferential-speed difference between the circumferential surfaces of the plate cylinder 2 and the second dampening solution applicator roller 5 to avoid the aforementioned framing effect. However, there may be a circumferential-speed difference that is very small in comparison between the circumferential speed of the circumferential surface formed by the printing plate on the plate cylinder 2 and the surface speed of the circumferential surface of the second dampening solution applicator roller 5, i.e. a circumferential-speed difference that is small enough to suppress the framing effect to a sufficient extent.

As is shown in FIG. 4, the motor 22 of the dampening unit 3 illustrated in FIG. 3 may be eliminated if the distributor roller 7 and the dampening unit roller 20 are in driving connection through a continuously variable transmission 24 and are drivable by a common electric motor 23 that is separate from the main drive. The continuously variable transmission 24 permits continuous variation of the difference between the rotational speed of the first dampening solution applicator roller 4 and the rotational speed of the second dampening solution applicator roller 5.

1. A method of operating a dampening unit in a printing press, the method comprising the following steps:
providing a first dampening solution applicator roller rolling on a plate cylinder with slip relative to the plate cylinder;
providing a second dampening solution applicator roller simultaneously rolling on the plate cylinder; and
providing a circumferential surface-speed difference between the first dampening solution applicator roller and the second dampening solution applicator roller.

2. The method according to claim 1, wherein the second dampening solution applicator roller rolls on the plate cylinder without slip relative to the plate cylinder.

3. The method according to claim 1, which further comprises providing a slip of the second dampening solution applicator roller relative to the plate cylinder being smaller than the slip of the first dampening solution applicator roller relative to the plate cylinder.

4. The method according to claim 1, which further comprises providing a circumferential surface-speed difference between the first dampening solution applicator roller and the plate cylinder having a percentage value of at least five in terms of a circumferential surface speed of the plate cylinder.

5. The method according to claim 4, wherein a circumferential surface speed of the first dampening solution applicator roller is at most 95% of the circumferential surface speed of the plate cylinder.

6. The method according to claim 1, wherein a circumferential surface speed of the second dampening solution applicator roller ranges from 97% to 103% of a circumferential surface speed of the plate cylinder.

7. The method according to claim 6, wherein the circumferential surface speed of the second dampening solution applicator roller ranges from 97% to 101% of a circumferential surface speed of the plate cylinder.

8. The method according to claim 1, wherein the second dampening solution applicator roller is disposed downstream of the first dampening solution applicator roller in rotation direction of the plate cylinder.

9. The method according to claim 1, which further comprises:
contacting the first dampening solution applicator roller and the second dampening solution applicator roller with a dampening unit roller; and
driving the second dampening solution applicator roller with a gear mechanism including a first gearwheel coaxial with the dampening unit roller and a second gearwheel coaxial with the second dampening solution applicator roller and meshing with the first gearwheel.

10. A printing press, comprising a dampening unit for implementing the method according to claim 1.
